(19) United States
(12) Patent Application Publication
(10) Pub. No.: US 2009/0164949 A1
(43) Pub. Date: Jun. 25, 2009

(54) Hybrid Contextual Advertising Technique

(75) Inventors: Assaf Henkin, Tel Aviv (IL); Yoav Shaham, Raanana (IL); Itai Brickner, Tel Aviv (IL)

Correspondence Address: Weaver Austin Villeneuve & Sampson LLP, P.O. BOX 70250, OAKLAND, CA, 94612-0250, US

(73) Assignee: Kontera Technologies, Inc., San Francisco, CA (US)

(21) Appl. No.: 12/340,464

(22) Filed: Dec. 19, 2008

Related U.S. Application Data
(60) Provisional application No. 61/015,380, filed on Dec. 20, 2007.

(51) Int. Cl. G06F 3/048

(52) U.S. Cl. 715/862

(57) ABSTRACT

At least one technique is disclosed for presenting information to a first end user via a first display of a client system, the client system being communicatively coupled to a computer network. In at least one embodiment, the method includes: displaying, at the first display, during a first time interval, a first portion of displayed content, wherein the displaying of the first portion of displayed content includes displaying a first portion of original web page content at the first display in accordance with instructions for modifying the displayed appearance of the first portion of original web page content; detecting a location of a cursor displayed at the first display being positioned over a first specific portion of the first portion of displayed content; and automatically displaying, during a second time interval and in response to detecting the location of the cursor being positioned over the first specific portion of the first portion of displayed content, a first overlay layer at the first display, wherein the display of the first overlay layer includes displaying, at the first overlay layer, first and second portions of contextually related information; wherein the first portion of contextually related information includes video content which is contextually related to the first portion of original web page content; and wherein the second portion of contextually related information includes a first portion of text which is contextually related to the first portion of original web page content.

### RELATED APPLICATION DATA

The present application claims benefit under 35 U.S.C. §119 of U.S. Provisional Application Ser. No. 61/015,380 (Attorney Docket No. KABAP012P), naming Henkin et al. as inventors, and filed Dec. 20, 2007.

### BACKGROUND

Over the past decade the Internet has rapidly become an important source of information for individuals and businesses. The popularity of the Internet as an information source is due, in part, to the vast amount of available information that can be downloaded by almost anyone having access to a computer and a modem. Moreover, the internet is especially conducive to conduct electronic commerce, and has already proven to provide substantial benefits to both businesses and consumers.

Many web services have been developed through which vendors can advertise and sell products directly to potential clients who access their websites. To attract potential consumers to their websites, however, like any other business, requires target advertising. One of the most common and conventional advertising techniques applied on the Internet is to provide advertising promotions (e.g., banner ads, pop-ups, ad links) on the web page of another website which directs the end user to the advertiser's site when the advertising promotion is selected by the end user. Typically, the advertiser selects websites which provide context or services related to the advertiser's business.

Conventionally, the process of adding contextual advertising promotions to web page content is both resource intensive and time intensive. In recent years the process has been somewhat automated by utilizing software applications such as application servers, ad servers, code editors, etc. Despite such advances, however, the fact remains that conventional contextual advertising techniques typically require substantial investments in qualified personnel, software applications, hardware, and time.

Furthermore, conventional on-line marketing and advertising techniques are often limited in their ability to provide contextually relevant material for different types of web pages.

As access to the Internet becomes more available, there is a greater potential to gather data relating to user behaviors and activities, and to present contextually relevant advertisements to different markets of people who are able to access the Internet.

### SUMMARY

At least one technique is disclosed for presenting information to a first end user via a first display of a client system, the client system being communicatively coupled to a computer network. In at least one embodiment, the method includes: receiving, at the client system, a first portion of original web page content to be displayed at the client system, wherein the first portion of original web page content corresponds to a portion of a first web page accessible via a first URL associated with a first content provider; receiving, at the client system, a first set of web page modification instructions, wherein the first set of web page modification instructions includes instructions for modifying a displayed appearance of the first portion of original web page content to be displayed at the client system, wherein the first set of web page modification instructions further includes instructions for displaying a first portion of contextually related information and a second portion of contextually related information at the client system, and wherein the first and second portions of contextually related information are different from the first portion of original web page content; displaying, at the first display, during a first time interval, a first portion of displayed content, wherein the displaying of the first portion of displayed content includes displaying the first portion of original web page content at the first display in accordance with the instructions for modifying the displayed appearance of the first portion of original web page content, and wherein the displaying of the first portion of displayed content during the first time interval does not include displaying the first and second portions of contextually related information; detecting a location of a cursor displayed at the first display being positioned over a first specific portion of the first portion of displayed content; and automatically displaying, during a second time interval and in response to detecting the location of the cursor being positioned over the first specific portion of the first portion of displayed content, a first overlay layer at the first display, wherein the display of the first overlay layer includes displaying, at the first overlay layer, the first and second portions of contextually related information; wherein the first portion of contextually related information includes video content which is contextually related to the first portion of original web page content, and wherein the display of the first portion of contextually related information includes displaying, at the first overlay layer, a sequence of video frames corresponding to the video content; wherein the second portion of contextually related information includes a first portion of text which is contextually related to the first portion of original web page content, wherein the first portion of text is associated with a second web page accessible via a second URL, and wherein the display of the second portion of contextually related information includes displaying, at the second overlay layer, the first portion of text.

### BRIEF DESCRIPTION OF THE DRAWINGS

FIG. 1 shows a block diagram of a computer network portion 100 which may be used for implementing various aspects of the present invention in accordance with a specific embodiment.

FIG. 2 shows a block diagram of various components and systems of a Kontera Server System 200 which may be used for implementing various aspects of the present invention in accordance with a specific embodiment.

FIG. 3A shows a flow diagram illustrating various information flows and processes of the present invention which may occur at various systems in accordance with a specific embodiment.

FIG. 3B shows an alternate embodiment of flow diagram illustrating various information flows and processes which may occur at various systems in accordance with a specific embodiment.

FIGS. 4A-G provide examples of various screen shots which illustrate different techniques which may be used for modifying web page displays in order to present additional contextual advertising information.

FIGS. 5 and 6 show examples of alternate embodiments of graphical user interfaces (GUIs) which may be used for implementing various aspects of the hybrid contextual advertising techniques described herein.

FIG. 7 shows an example embodiment of a customized JavaScript (“JS”) Kontera Tag portion 700.

### DETAILED DESCRIPTION OF EXAMPLE EMBODIMENTS

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Online Content Publishers (OCP) generate revenue from advertising that they display on their site. Their revenue growth is driven by the amount of users that visit their site, the ad rates they can charge, and the effectiveness of the ads they display on their site. All of this will translate into an average amount of revenue that the site will generate per every 1,000 page views. A page view occurs when a specific user views a specific page of that site. This average revenue per 1,000 pages is often referred to as “eCPM” or effective cost per mega.

For example, expression (1) below illustrates one example of how an OCP's revenue may be calculated:

Revenue=# Impressions/# Clicks*Impression/Click Rate (1)

In at least one embodiment, click rate may be driven by the conversion rates that the clicks translate into for advertisers. Click conversion may be driven by the level of relevancy the ad offering has to the user's interest.

Though OCPs are constantly trying to increase revenue, OCPs are aware of the fact that short term revenue might come at the expense of long term revenue. Meaning that if they try to increase revenue in the short term using methods that will alienate users, they will lose those users in the long term and therefore there page view volume will decline and with it revenue.

Accordingly, one aspect described herein relates to various techniques for allowing an OCP to increase revenue while providing a valuable service that will keep users coming back to their site and possible viewing more pages.

Aspects of the following disclosure describe various embodiments for increasing revenue potential which may be generated via on-line contextual advertising techniques such as those employing contextual in-text keyword advertising techniques for displaying advertisements to end users of computer systems.

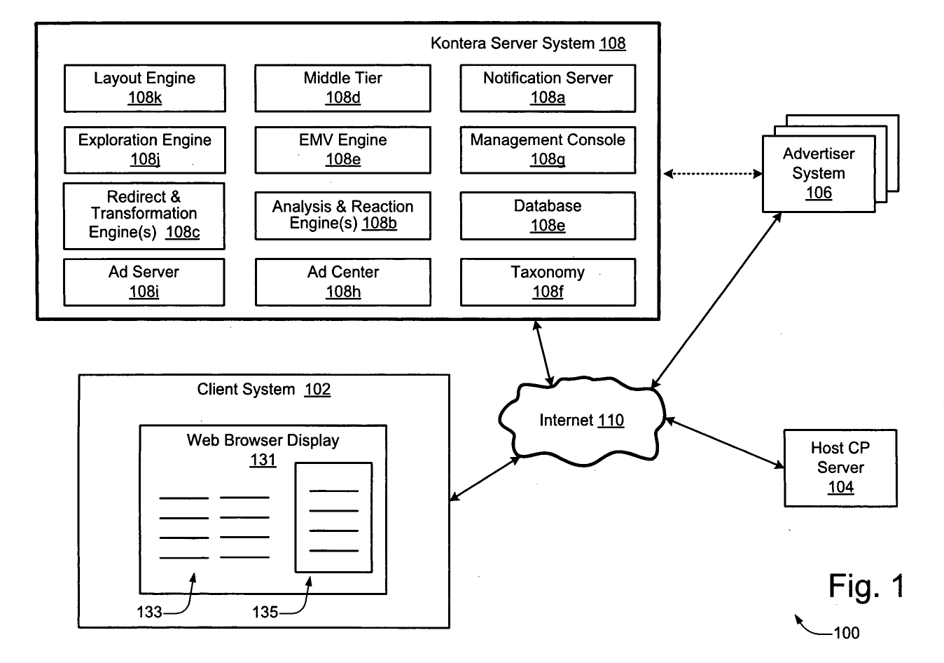

FIG. 1 shows a block diagram of a computer network portion 100 which may be used for implementing various aspects of the present invention in accordance with a specific embodiment. As illustrated in FIG. 1, network portion 100 includes at least one client system 102, at least one host server or content provider (CP) server 104, at least one advertiser system 106, and at least one contextual analysis and response server (herein referred to as “Kontera Server System” or “Kontera Server”) 108.

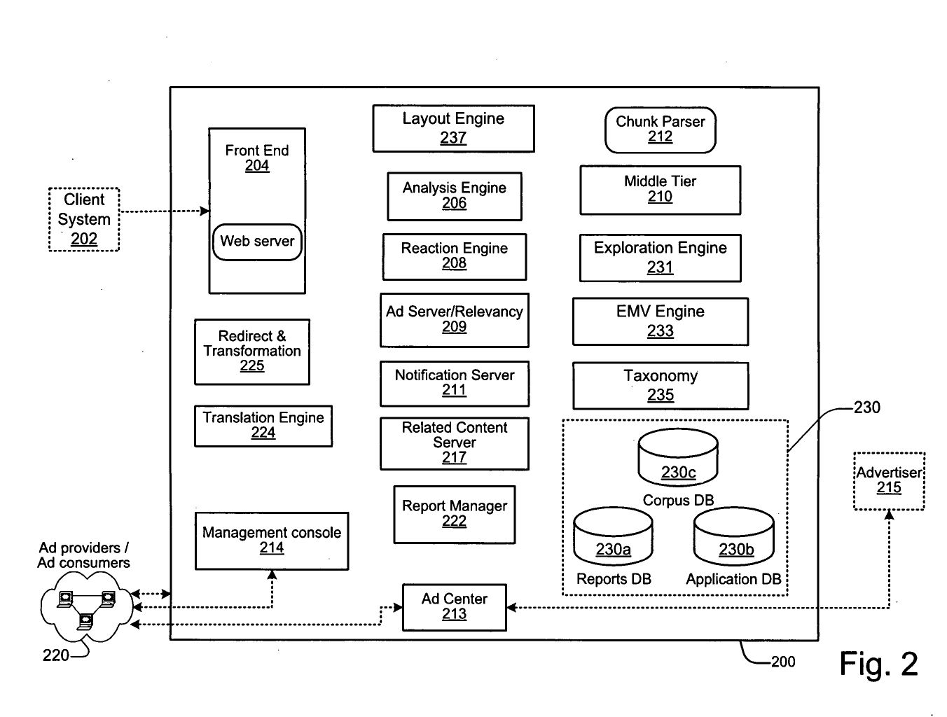

In at least one embodiment, the Kontera Server System 108 may be configured or designed to implement various aspects of the present invention including, for example, real-time web page context analysis and/or real-time insertion of textual markup objects and dynamic content. In the example of FIG. 1, the Kontera Server System 108 is shown to include one or more of the following components: an Ad Server module 108i, a Notification Server 108a, Analysis & Reaction Engine(s) 108b, Redirect & Transformation Engine(s) 108c, a Middle Tier component 108d, a database 108e, a Taxonomy component 108f, a Management Console 108g, an Ad Center component 108h, an Exploration Engine 108j, a Layout Engine 108k, an EMV (Estimated Monetary Value) Engine 108m, etc. It will be appreciated that other embodiments may include fewer, different and/or additional components than those illustrated in FIG. 1. A number of these components are described in greater detail below (such as, for example, with reference to FIGS. 2, 12A, and 12B of the drawings).

In example embodiments, the client system 102 may include a Web browser display 131 adapted to display content 133 (e.g., text, graphics, links, frames 135, etc.) relating desired web pages, file systems, documents, advertisements, etc.

It will be appreciated that other embodiments may include fewer, different and/or additional components than those illustrated in FIG. 1.

In one embodiment, such analysis and/or calculations may be implemented in real-time (or near real-time) in order allow one technique(s) described herein to automatically and dynamically adapt, in real-time, its algorithms and/or other mechanisms for selecting and/or estimating potential revenue relating to on-line contextual advertising techniques such as those employing contextual in-text keyword advertising.

Additionally, in some example embodiments, aspects of the present invention may be applied to real-time advertising in situations where selected keywords (KWs) are not located in the content of the page or document. For example, referring to FIG. 1, various techniques according to embodiments of the present invention may be applied to content (e.g., 133) in the main body of a web page and/or to content in frames such as, for example, Ad Frame portion 135, which, for example, may be used for displaying advertisements (or other information) that is not included as part of the original content of the web page. Moreover, these techniques may also be used to analyze dynamically generated content such as, for example, content of a web page which dynamically changes with each refresh of the URL. In at least one embodiment, it is also possible to display ads directly based on keywords and/or topics identified in the Ad Frame portion 135. In one example embodiment, performance of a keyword may be based, at least in part, on how many clicks are generated for the associated ad.

For purposes of illustration, an exemplary embodiment of FIG. 1 will be described for the purpose of providing an overview of how various components of the computer network portion 100 may interact with each other. In this example, it is assumed at that a user at the client system 102 has initiated a URL request to view a particular web page such as, for example, www.yahoo.com. Such a request may be initiated, for example, via the Internet using an Internet browser application at the client system. According to a specific embodiment, when the URL request is received at the content provider server 104, server 104 responds by transmitting the URL request info and/or web page content (corresponding to the requested URL) to the Kontera Server System 108. In a specific embodiment where the Kontera Server System receives only the URL request information from the content provider server, the Kontera Server System may request the web page content (corresponding to the requested URL) from the content provider server 104. The server 104 may then respond by providing the requested web page content to the Kontera Server System.

According to specific embodiments, as the Kontera Server System 108 receives the web page content from the content provider server 104, it analyzes, in real-time, the received web page content (and/or other information) in order to generate page information (e.g., page classifier data) and keyword information (e.g., list identified keywords on page which may be suitable for highlight/mark-up). The keyword information may then be used to retrieve or identify one or more ad candidates from advertisers (e.g., Advertiser System 106). In one embodiment, each ad candidate may include one or more of the following: title information relating to the ad; a description or other content relating to the ad; a click URL that may be accessed when the user clicks on the ad; a landing URL which the user will eventually be redirected to after the click URL action has been processed; cost-per-click (CPC) information relating to one or more monetary values which the advertiser will pay for each user click on the ad; etc.

According to a specific embodiment, it is possible for the Kontera Server System 108 to receive different contextual ad information from a plurality of different advertiser systems. In one embodiment, the received ad information (and/or other information associated therewith) may be analyzed and processed to generate relevance information, estimated value information, etc. The identified ad candidates may then be ranked, and specific ads selected based on predetermined criteria. Once a desired ad has been selected, the Kontera Server System may then generate web page modification instructions for use in generating contextual in-text keyword advertising for one or more selected keywords of the web page.

According to a specific embodiment, the web page modification operations may be implemented automatically, in real-time, and without significant delay. As a result, such modifications may be performed transparently to the user. Thus, for example, from the user's perspective, when the user requests a particular web page to be retrieved and displayed on the client system, the client system will respond by displaying a modified web page which not only includes the original web page content, but also includes additional contextual ad information. If the user subsequently clicks on one of the contextual ads, the user's click actions may be logged along with other information relating to the ad (such as, for example, the identity of the sponsoring advertiser, the keywords(s) associated with the ad, the ad type, etc.), and the user may then be redirected to the appropriate landing URL. According to specific embodiments, the logged user behavior information and associated ad information may be subsequently analyzed in order to improve various aspects of the present invention such as, for example, click through rate (CTR) estimations, estimated monetary value (EMV) estimations, etc.

FIG. 2 shows a block diagram of various components and systems of a Kontera Server System 200 which may be used for implementing various aspects of the present invention in accordance with a specific embodiment. At least a portion of the functionalities of various components shown in FIG. 2 are described below. It will be noted, however, other embodiments of the Kontera Server System may include different functionality than that shown and/or described with respect to FIG. 2.

As illustrated in the embodiment of FIG. 2, the Front End component 204 may include, for example, at least one web server, and may be configured or designed to handle requests from one or more client systems (e.g., 202).

The Analysis Engine 206 may be operable to perform real-time analysis of web page content. As illustrated in the example of FIG. 2, the Analysis Engine 206 may include various functionality, including, for example, but not limited to, one or more of the following: functionality for identifying keywords on selected web pages; functionality for combining or linking keywords into groups or concepts; functionality for identifying topics of a web page based on the identified keywords; functionality for identifying aliases for topics associated with selected web pages; functionality for determining various attributes of one or more client systems; functionality for collecting and analyzing user behavior information; functionality for tracking ad impression information; etc.

The Reaction Engine 208 may be operable to utilize information provided by the Analysis Engine 206 to generate real-time web page modification instructions to be implemented by the client system when rendering web page information. According to a specific embodiment, the web page modification instructions may include instructions relating to the insertion of textual markup objects and/or dynamic content for selected web pages being displayed on the client system. As illustrated in the example of FIG. 2, the Reaction Engine 208 may include various functionality, including, for example, but not limited to, one or more of the following: functionality for identifying links between web pages of the same web site and/or between web pages from different web sites.; functionality for filtering advertisements based upon predetermined criteria (such as, for example, publisher preferences); functionality for storing information relating to previous analysis of web pages; functionality for selecting or determining recommended web page modification instructions based upon selected user profile information (e.g., user click behavior, Geolocation, etc.); etc.

The Ad Server/Relevancy module 209 may be operable to manage and/or provide access to advertising information and/or related keyword information. For example, In at least one embodiment, Ad providers 220 (e.g., Yahoo, Looksmart, Ask.com, etc.), advertisers, and/or ad campaign providers/managers may provide to the Ad Server/ Relevancy module 209 one or more advertisements (ads) relating to one or more different keywords. The Ad Server/ Relevancy module 209 may be operable to determine and/or store a respective relevancy score for each ad. Additionally, the Ad Server/ Relevancy module 209 may be operable to determine and/or store other ad related information such as, for example: related page topic information, cost-per-click (CPC) information, etc. The Ad Server/Relevancy component 209 may also be operable to be queried by one or more other components/systems such as, for example, Reaction Engine 208. For example, in one embodiment, the Reaction Engine may query the Ad Server/Relevancy module for information relating to a particular ad or keyword, and the Ad Server/Relevancy module may respond by providing relevant information which, for example, may be used by the Reaction Engine to facilitate the selection of one or more keyword/ad candidates.

In at least some embodiments, Ad Server/Relevancy module 209 may be operable provide a variety of other functionalities and/or features, which, for example, may include, but are not limited to, one or more of the following (or combination thereof): functionality for providing identifying and selecting ads that are relevant to the content of the page; functionality for providing analysis operations; functionality for generating ad and page classifier data; functionality for generating ad relevancy scores; etc.

The Redirect & Transformation Engine 225 may be operable to include redirect, translation and/or tracking functionality. For example, in at least one embodiment, the Redirect &Transformation Engine224 may include various functionality, including, for example, but not limited to, one or more of the following: functionality for redirecting clients to a specified destination; functionality for analyzing and translating data relating to user activity into desired user behavior information; functionality for translating ad related data into displayable format, functionality for tracking and storing information relating to user behaviors, clicks and/or impressions; etc.

Management console 214 may be operable to provide a user interface for creating and viewing reports, setting system configurations and parameters. According to a specific embodiment, the management console 214 may be configured or designed to allow content providers and/or advertisers to access the Kontera Server System in order to, for example: access desired information stored at the Kontera Server System (e.g., keyword taxonomy information, content provider information, advertiser information, etc.); manage and generate desired reports; manage information relating to one or more ad campaigns; etc.

Notification Server 211 operable to manage ad update information and/or related activities or events. In at least one embodiment, the Notification Server 211 may be operable to manage ad update activities, events, and/or related information in real-time.

A Related Content Server 217 operable to perform related content analysis of selected content, and operable to determine, select and/or acquire related content information to be displayed to a user via the client system display, for example.

According to specific embodiments, EMV Engine 233 may be operable provide a variety of functionalities and/or features, which, for example, may include, but are not limited to, one or more of the following (or combination thereof): functionality for providing estimates of the Expected Monitory Value for specified Page, Highlight, ad combinations; functionality for providing analysis and tracking operations; functionality for providing learning users behavior to re-estimate the EMV estimates; functionality for providing back-off estimates; functionality for providing Logistic Regression operations; etc.

According to specific embodiments, Layout Engine 237 may be operable provide a variety of functionalities and/or features, which, for example, may include, but are not limited to, one or more of the following (or combination thereof): functionality for identifying and selecting highlights (e.g., keyword highlights) to be displayed; functionality for generating ad rankings; functionality for providing reaction operations; etc.

According to specific embodiments, Exploration Engine 231 may be operable provide a variety of functionalities and/or features, which, for example, may include, but are not limited to, one or more of the following (or combination thereof): functionality for exploring ads that may yield better value than current ads; functionality for interacting with layout engine, for example, to understand which highlight may be explored; functionality for providing tracking and reaction; etc.

Other components of the Kontera Server System 200 may include, but are not limited to, one or more of the following (or combinations thereof): a chunk parser 212 (such as, for example, a part-of-speech text processor) operable to parse chunks of received web page content and/or to perform analyses of the text syntax; a Middle Tier component 210 configured or designed to include data warehouse and business logic functionality; at least one database 230 for storing information such as, for example, web page analysis information, application data, reports, taxonomy information, ontology information, page corpus information, etc.; a report manager 222 for collecting and storing reports and other information from different components in the Kontera Server System; a Translation Engine 224 for translating or converting communications from one format type to another format type (e.g., from XML to HTML or vice versa); a parsing engine for parsing HTML into readable text; an Ad Center component 213 operable to provide a user interface to one or more advertisers or ad campaign managers (e.g., 215) for performing various operations such as, for example, setting up ad campaigns, managing ad campaigns, generating reports; a Taxonomy component 235 operable to manage, store and/or provide access to taxonomy information (which, for example, may include keyword related information and/or topic related information); etc.

One aspect of at least some embodiments described herein is directed to systems and/or methods for augmenting existing web page content with new hypertext links on selected keywords of the text to thereby provide a contextually relevant link to an advertiser's sites.

Other aspects are directed to one or more techniques for determining and displaying related links based upon keywords of a selected document such as, for example, a web page. For example, one embodiment may be adapted to link keywords from content on a web site (e.g., articles, new feeds, resumes, bulletin boards, etc.) to relevant pages within their site. In embodiments where the selected website includes multiple web pages (which, for example, may include static and/or dynamic web pages), the technique(s) described herein may be adapted to automatically and dynamically determine how to link from specific keywords to the most appropriate and/or relevant and/or desired pages on the website. In at least one embodiment, the most appropriate and/or relevant pages may include those which are determined to be contextually relevant to the specific keywords. For example, using the technique(s) described herein the keyword “DVD player” may be linked to a recently published article reviewing the latest DVD players on the market. In at least one embodiment, it may be preferable to link one or more keywords to pages, articles, URLs or other references which are determined to have the relatively greatest revenue potential as compared to a group of possible candidates which might be appropriate.

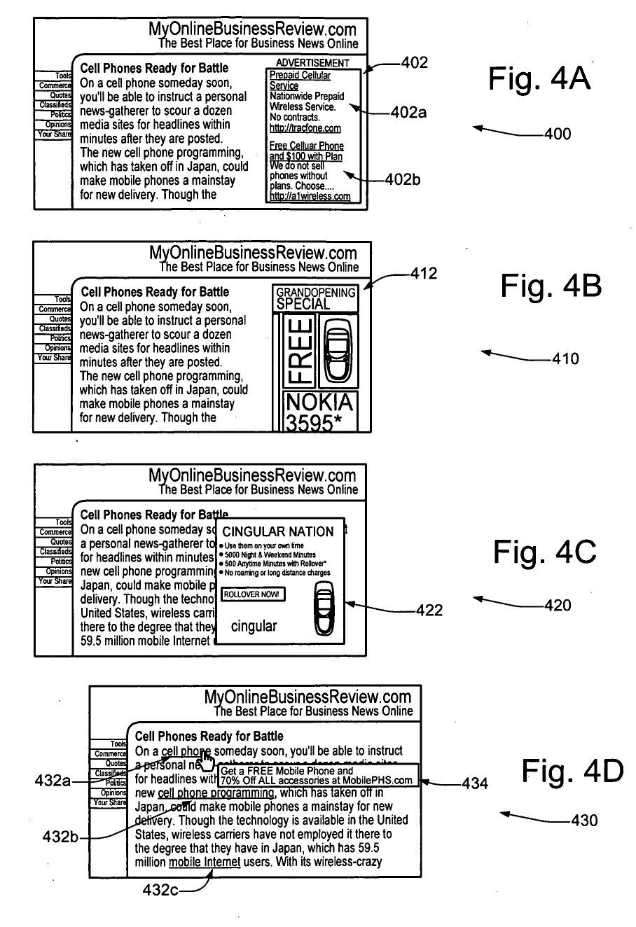

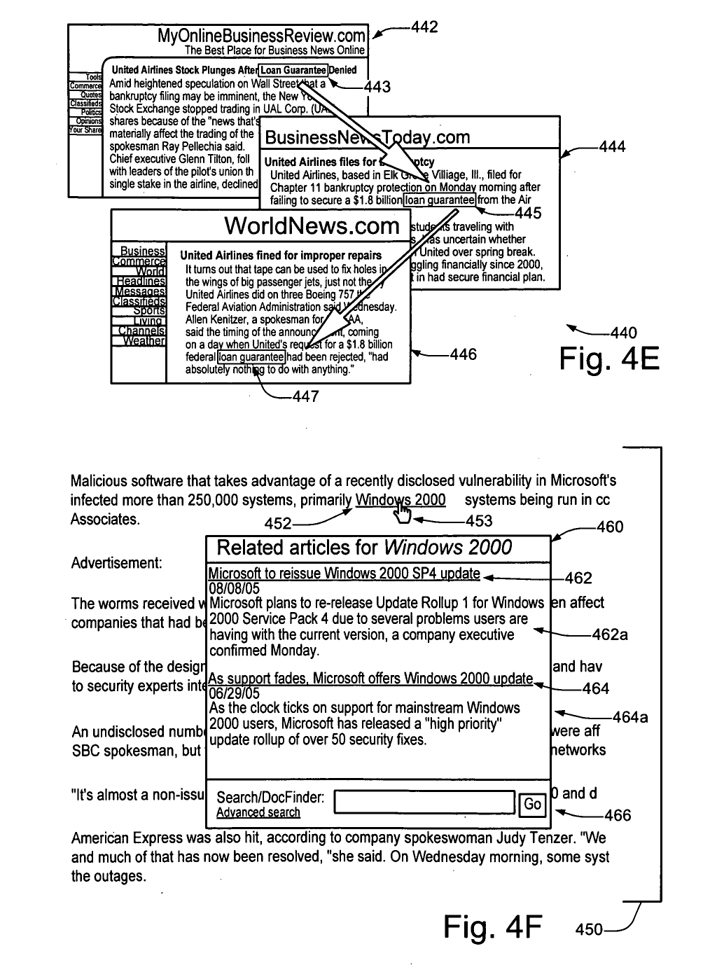

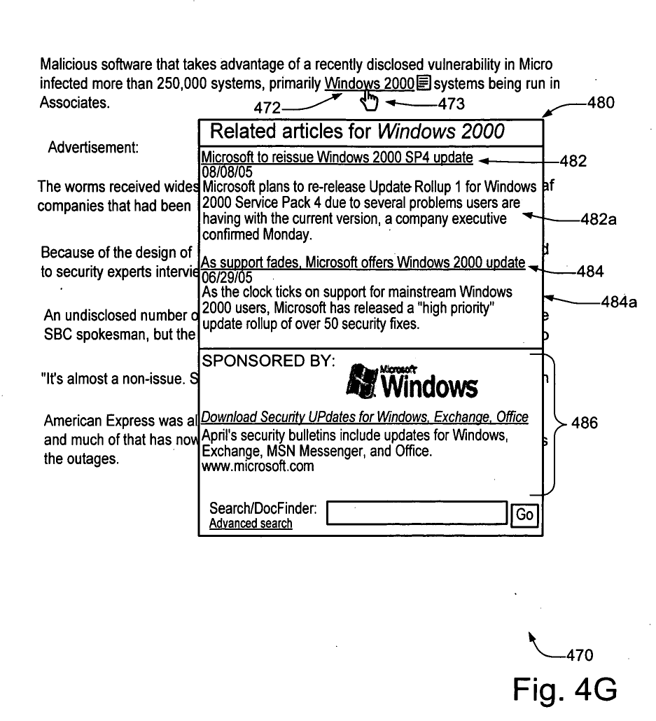

For purposes of illustration, the contextual advertising and markup techniques disclosed herein are described with respect to the use of ContentLinks. However, other embodiments of the present invention may utilize other types of advertising techniques which, for example, may be used for modifying displayed content (and/or for generating modified content) in order to present desired contextual advertising information on a client device display. Examples of at least some advertising techniques which may be utilized in one or more embodiments of the present invention are described, for example, in FIGS. 4A-G of the drawings.

FIGS. 4A-G provide examples of various screen shots which illustrate different techniques which may be used for modifying web page displays in order to present additional contextual advertising information.

FIG. 4A illustrates a technique (herein referred to as “TextMatch”) for placing additional relevant search listings (402a, 402b) or search results next to the relevant web page content. FIG. 4B illustrates a technique (herein referred to as “AdMatch”) for placing relevant marketing opportunities, promotions, graphics, commerce opportunities, ads (412), etc. next to the web page content. FIG. 4C illustrates a technique (herein referred to as “Contextual Pop-ups”) for placing relevant pop-up windows (422) on top or under the current page. The pop-up window(s) may include information relating to content, marketing opportunities, promotions, graphics, commerce opportunities, etc. FIG. 4D illustrates a technique (herein referred to as “ContentLinks”) for placing additional links (432a, 432b) to information (434) (e.g., content, marketing opportunities, promotions, graphics, commerce opportunities, etc.) within the existing text of the web page content by transforming (e.g., marking up) existing text (432a, 432b) into hyperlinks. In one embodiment, the additional information (e.g., 434) may be automatically displayed to the user via a tool-tip layer which may be activated or displayed when the user performs a “mouse over” action on (e.g., hovers the display pointer over) text (e.g., 432a) which has been marked up using one or more of the techniques described herein. In another embodiment, the user may be required to click on the marked up text or hyperlink (e.g., 432a) in order to cause the additional information (e.g., 434) to be displayed. FIG. 4E illustrates a technique (herein referred to as “Related Content Links”) for finding web pages (442, 444, 446) that relate to each other (e.g., by relevant topic or theme), finding relevant keywords (443, 445, 447) on those pages, and then transforming those relevant keywords into hyperlinks that link between the related pages.

FIG. 4F shows an example of a specific embodiment of a graphical user interface (GUI) which may be used for implementing various aspects of the present invention. In the example of FIG. 4F, it is assumed that the content of document 450 has been analyzed in accordance with a contextual analysis technique, and that selected keywords of the document have been identified. It is further assumed that at least a portion of the selected keywords have been linked to other selected resources (e.g., web pages, URLs, articles, etc.) using predetermined selection criteria. Thus, for example, as shown in FIG. 4F, when a user hovers the cursor 453 over the keyword “Windows 2000” (452), a GUI 460 may be displayed to the user, for example, via a pop-up layer (such as, for example, a mouse-over tool tip layer). In the embodiment of FIG. 4F, the GUI 460 includes several links (e.g., 462, 464) to articles relating to the keyword “Windows 2000”. GUI 460 may also include other information such as, for example, images and/or text descriptions (e.g., 462a, 464a) associated with each of the related article links; advertisements; dialog boxes (e.g., search box 466); etc.

FIG. 4G shows an example of an alternate embodiment of a graphical user interface (GUI) which may be used for implementing various aspects of the present invention. In the example of FIG. 4G, it is assumed that the content of document 470 has been analyzed in accordance with a contextual analysis technique, and that selected keywords of the document have been identified. It is further assumed that at least a portion of the selected keywords have been linked to other selected resources (e.g., web pages, URLs, articles, etc.) using predetermined selection criteria. Thus, for example, as shown in FIG. 4G, when a user hovers the cursor 473 over the keyword “Windows 2000” (472), a pop-up window or GUI 480 may be displayed to the user. In the embodiment of FIG. 4G, the GUI 480 includes several links (e.g., 482, 484) to articles relating to the keyword “Windows 2000”. GUI 480 may also include other information such as, for example, images and/or text descriptions (e.g., 482a, 484a) associated with each of the related article links; advertisements (e.g., 486); dialog boxes; etc.

Additionally, in specific embodiments of websites which include dynamically generated web pages with content populated from multiple sources, different mechanisms may be utilized which, for example, are adapted to maintain and/or manage the relationships between set(s) of keywords and dynamically changing list(s) of web pages. Examples of several of such mechanisms are described below.

For example, one or more embodiments may be integrated with the application(s) which a website is using for content management and production. One advantage of such a technique is that it may reduce or eliminate manual work required to be performed, for example, by a site manager. For example, in one embodiment, assuming that the site is using a specific application that manages the content (e.g., categorizes, etc.), it may be preferable to tie into that system in order to learn about the keyword-to-document relationships. Different embodiments may be operable to provide different features/functionalities which, for example, may include, but are not limited to, one or more of the following (or combination thereof): functionality for “reading” a list of documents where each document has an associated category and priority; functionality for connecting a list of keywords to the appropriate documents (based, for example, on a pre-determined relationship between keywords and categories); etc.

Other embodiments may be operable to allow content managers to classify documents into known list of categories. This may allow the site managers to relate specific documents to categories. The different keywords may then be linked to the appropriate documents based on the pre-existing relationship as described above. One advantage of this technique is that it may be implemented without requiring integration into existing applications.

Other embodiments may be operable to use pre-existing Meta information that the site adds to documents, and to categorize the documents based on that Meta info. For example, one embodiment may be adapted to crawl the web pages and/or documents (including, for example, documents which are stored in a database and/or are generated on-the-fly), and to create links from keywords to documents based on given relationships (such as those described herein, for example). In one embodiment, it is assumed that the document includes useful Meta info (e.g., that can be used for one or more purposes as described herein). In some embodiments, the content propagation cycles may be implemented on a period basis, and may be integrated into a crawling schedule.

Other embodiments may be operable to link to documents based on their site-section placement. Thus, for example, in one embodiment, links may be created from keywords of a specific category to the documents in the site's section that matches that category. This takes into consideration that the site's section(s) are somewhat “match able” to the keyword categories.

In at least one embodiment, one or more of the above-described embodiments may be implemented without requiring integration into existing applications.

Other embodiments may be operable to link to documents based on priorities assigned by an operator (such as, for example, a Kontera employee or a CP employee) to specific site sections and/or specific pages. According to a specific embodiment, such priorities may be added to the process that determines which links could be offered for a specific keyword. For example, in at least one embodiment, such priorities may be desirable, for example, in situations where more than one link is relevant(e.g., within a given relevancy spectrum), and it is desired to prioritize the linking of a specific site section or page (e.g., because that section or page may have a higher monetary value associated with it). According to some embodiments, at least some features relating to the real-time contextual advertising techniques described herein may be implemented via the use of dynamic context tags which have been included in selected web pages of an online publisher or content provider. For example, in at least one embodiment, a content provider (such as, for example, on-line publishers or other website operators providing on-line content) may insert one or more dynamic context tags (such as, for example, a Java script tag) into all or selected web pages of a website which, for example, may be hosted by the content provider. In one embodiment, the dynamic context tag information may include a content provider ID which is uniquely associated with that specific content provider. According to a specific embodiment, a dynamic context tag may include various information such as, for example, the content provider ID, information relating to one or more desired ad types (such as, for example, TextMatch, AdMatch, Contextual Pop-ups, ContentLink, Related Content Links, etc.) to be used on the associated web page, script instructions (e.g., JavaScript™ code) to be implemented at the client system; etc. In one embodiment, the dynamic context tag may be physically inserted into each of the selected web pages. Alternatively, the dynamic context tag information may be inserted into the page via a tag that is already all the page such as, for example, and ad server tag or an application server tag. Once present on the page, the dynamic context tag may be served as part of the page that is served from the content provider's web server(s).

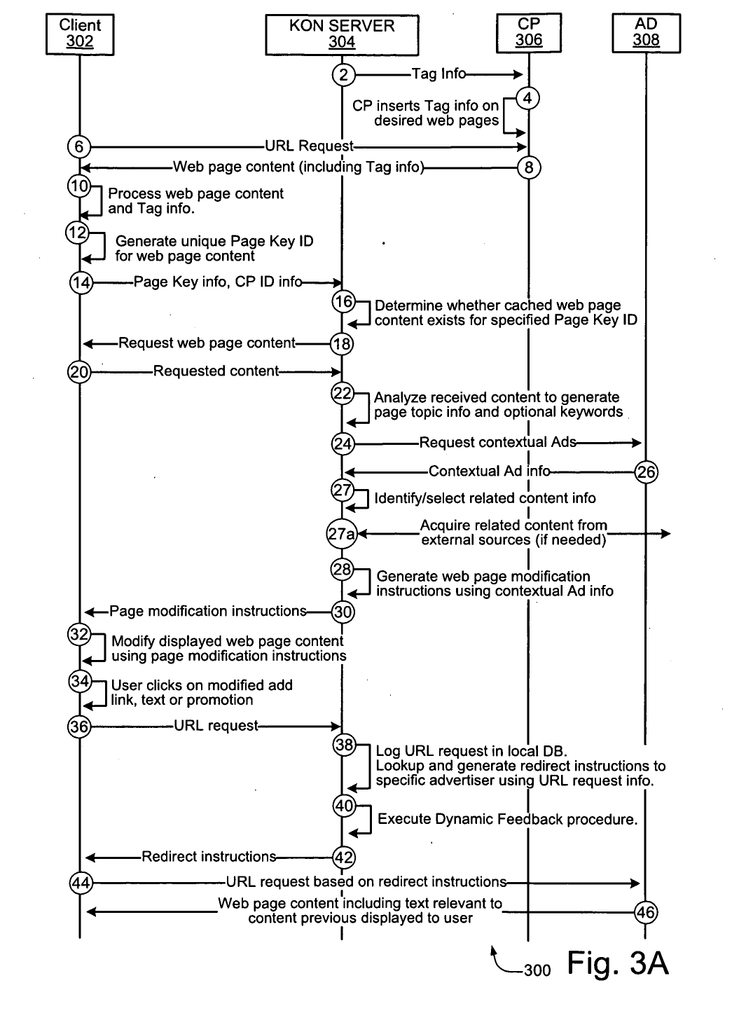

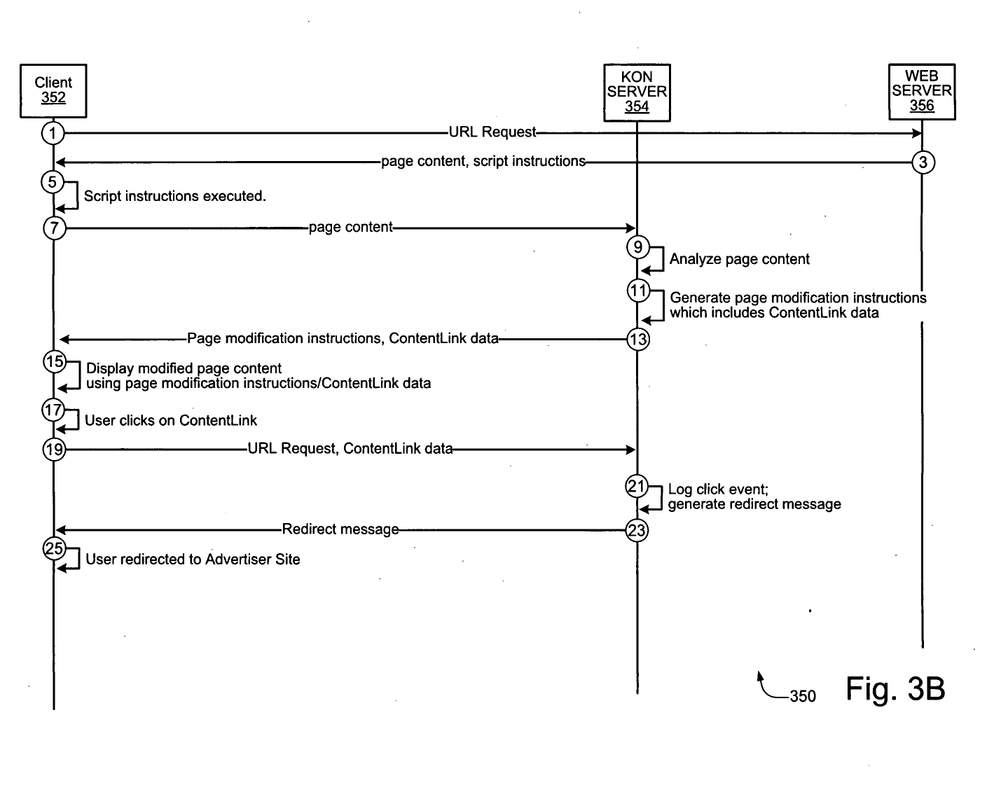

FIG. 3A shows a flow diagram illustrating various information flows and processes of the present invention which may occur at various systems in accordance with a specific embodiment. According to a specific implementation, a content provider (such as, for example, on-line publishers or other website operators providing on-line content) desiring to utilize the real-time contextual advertising features of the present invention may obtain a unique content provider ID. In one implementation, the unique content provider ID may be assigned or provided by the Kontera Server System. In a specific embodiment, the unique content provider ID information may be embedded into a dynamic context tag (such as, for example, a Java script tag) which may then be inserted into the content provider's web pages.

Thus, for example, as illustrated in the example of FIG. 3A, the Kontera Server System (KON) 304 provides (2) dynamic context tag information which includes the unique content provider ID to the content provider server (CP) 306. In at least one implementation, the content provider may utilize the dynamic context tag information to generate one or more dynamic context tags to be inserted (4) on selected web pages which the content provider has identified for utilizing the real-time contextual advertising features of the present invention. According to a specific embodiment, each dynamic context tag may include information relating to the content provider ID, and may also include information relating to one or more desire to add types (e.g., TextMatch, AdMatch, Pop-up, ContentLink, Related Content Links, etc.) for the corresponding web page. In one embodiment, the dynamic context tag may be physically inserted into each of the selected web pages. Alternatively, the dynamic context tag information may be inserted into the page via a tag that is already all the page such as, for example, and ad server tag or an application server tag. Once present on the page, the dynamic context tag will be served as part of the page that is served from the content provider's web server(s).

For example, as shown in FIG. 3A, it is assumed at (6) that a user at the client system 302 has initiated a URL request to view a particular web page such as, for example, www.yahoo.com. Such a request may be initiated, for example, via the Internet using an Internet browser application at the client system. When the URL request is received at the content provider server 306, the server responds by transmitting or serving (8) web page content, including the dynamic context tag, to the client system 302. The client system will then process (10) the received web page content including the dynamic context tag, which includes dynamic context tag information relating to the content provider ID and desired ad types for the retrieved web page. According to a specific embodiment, the processing of the dynamic context tag information will invoke a Java script operation which causes the client system to generate (10) a unique page key ID for the received web page content, and to transmit (12) the page key ID information, desired ad type information, and content provider ID information to the Kontera Server System 304. In at least one embodiment, a page key ID represents a unique identifier for a specific web page, and may be generated based upon text, structure and/or other content of that web page. In a specific implementation, the page key ID is not based upon the identity of the user, client system, or content provider. However, the page key ID may be used to uniquely identify personalized web pages, customized web pages, and dynamically generated web pages.

Upon receiving the page key ID information and content provider ID information, the Kontera Server System uses this information to determine (16) whether a cached version of the web page corresponding to the page key ID already exists within the Kontera Server System cache. According to a specific embodiment, if it is determined that a cached version of the web page exists at the Kontera Server System, then flow may commence starting at operation (24) of FIG. 3A, which is described in greater detail below. However, for purposes of illustration, it is assumed that a cached version of the web page does not exist at the Kontera Server System. Accordingly, the Kontera Server System request (18) the client system to provide at least a portion of the web page content. The client system responds by transmitting (20) the requested web page content to the Kontera Server System. In the specific implementation, the requested content may be transmitted to the Kontera Server System in chunks which may span the one or more sessions.

As the Kontera Server System receives the web page content from the client system, it analyzes (22), in real-time, the received web page content in order to generate page topic information and/or keyword information. According to a specific implementation, the keyword information may include, for example, taxonomy keywords, ontology (or “ContentLink”) keywords, keyword ranking information, primary keyword information, etc. The page topic information may include one or more page topics associated with the web page currently being analyzed. In at least one embodiment, taxonomy keywords may correspond to words or phrases in the web page content which relate to the topic or subject matter of the web page. Ontology or ContentLink keywords may correspond to words or phrases in the web page content which may have advertising value. In some cases, it is possible for a word or phrase to be classified as both a taxonomy keyword and an ContentLink keyword.

In at least one implementation, the Kontera Server System may continue to request and analyze web page content for the specified web page until it has generated a sufficient amount of keyword information (e.g., 5 or more taxonomy keywords and 5 or more ontology keywords), until it has generated a sufficient amount of page topic information, and/or until the entirety of the web page content has been analyzed. Once the Kontera Server System has finished performing its analysis of the web page content, it may then submit a request (24) to one or more advertiser systems 308 for contextual ad information. According to specific embodiments, the ad request(s) may be based on various criteria such as, for example, publisher preferences, page topic information, desired ad data, keyword information, page topic information, etc. Each advertiser system may, in turn, process the ad information request in order to determine if it has relevant advertising information which matches the specified criteria. If so, the advertiser system 308 may transmit (26) contextual ad information to the Kontera Server System.

Additionally, in at least one embodiment, the Kontera Server System may use the keyword and/or topic information to determine and/or select (27) “related content” information which contextually related to content from the current site (e.g., that the user is currently browsing). In at least one embodiment, at least a portion of this operation may be performed by the related content server 217 (FIG. 2). In at least one embodiment, such related content information may include or may consist entirely of content which is not provided by the advertiser system 308. In some embodiments, when desired, at least a portion of the related content information may be retrieved or acquired (27a) from one or more external/remote sources (e.g., from sources other than Kontera Server System 304, content provider system 306, or advertiser system 308) such as, for example, third party content sites such as, for example, youtube.com, facebook.com, wikipedia.com, cnn.com, etc. In other embodiments, the related content information may include contextually related advertising content relating to additional/other sites that can be affiliated with (or, alternatively, not affiliated with) the current site. In at least one embodiment, the contextual ad information and/or related content information may include a variety of different information such as, for example, text, images, HTML, scripts, video, audio, proprietary rich media, etc. In addition, the contextual ad information and/or related content information may also include URL information and financial information such as, for example, cost per click (CPC) information.

For example, in at least one embodiment, the contextual ad information may include, for example: title information relating to the ad, ad description information, a “click” URL that is to be accessed when the user clicks on the ad, a “landing” URL where the user will eventually be redirected to after the click URL action has been processed, cost-per-click (CPC) information which may include cost-per-click information relating to one or more monetary values which the advertiser will pay for each user click on the ad; and/or some combination thereof.

According to a specific embodiment, it is possible for the Kontera Server System 304 to receive different contextual ad information from a plurality of different advertiser systems. In one implementation, the received ad information may be sorted and/or ranked according to predetermined criteria (such as, for example, CPC criteria, revenue criteria, expected return criteria, type of ad, likelihood of user clicks, statistical historical data, etc.) in order to select the desired ad to be used.

In one embodiment, the related content information may include, for example: title information relating to selected related content, selected related content description information, a “click” URL that is to be accessed when the user clicks on the selected related content, a “landing” URL where the user will eventually be redirected to after the click URL action has been processed, cost-per-click (CPC) information which may include cost-per-click information relating to one or more monetary values which the advertiser will pay for each user click on the selected related content; and/or some combination thereof.

According to a specific embodiment, it is possible for the Kontera Server System 304 to acquire different related content information from a plurality of different external sources. In one implementation, the received selected related content information may be sorted and/or ranked according to predetermined criteria (such as, for example, CPC criteria, revenue criteria, expected return criteria, type of selected related content, likelihood of user clicks, statistical historical data, etc.) in order to select the desired selected related content to be used.

Assuming a desired ad has been selected, the Kontera Server System may then generate (28) web page modification instructions using, for example, the contextual ad information associated with the selected ad, and the desired ad type information specified by the content provider. Additionally, assuming a specific portion of related content has been selected for display, the Kontera Server System may also generate (28) web page modification instructions using, for example, the selected related content information. According to a specific embodiment, the web page modification instructions may include keyword impression information which may be logged at the Kontera Server System database.

According to a specific embodiment, the web page modification instructions may include keyword impression information which may be logged at the Kontera Server System database.

Once the web page modification instructions have been generated, they are transmitted (30) to the client system. In a specific embodiment, the web page modification instructions may be implemented using a scripting language such as, for example, Java script. When the web page modification instructions are received at the client system, the client system processes the instructions, and in response, modifies (32) the display of the web page content in accordance with the page modification instructions.

According to at least one embodiment, the web page modification instructions may include instructions for modifying, in real-time, the display of web page content on the client system by inserting and/or modifying textual markup information and/or dynamic content information. Because the web page modification operations are implemented automatically, in real-time, and without significant delay, such modifications may be performed transparently to the user. Thus, for example, using the technique(s) described herein, when the user submits a URL request at the client system to view a web page (such www.yahoo.com, for example), the client system will receive web page content from www.yahoo.com, and will also receive web page modification instructions from the Kontera Server System. The client system will then render the web page content to be displayed in accordance with the received web page modification instructions. Examples of various screen shots which illustrate different techniques which may be used for modifying web page displays in order to present additional contextual advertising information are illustrated, for example, in FIGS. 4A-4G of the drawings.

At (34) it is assumed that the user has clicked on one of the contextual ads which was dynamically inserted into the web page content using the above-described technique. According to at least one embodiment, the action of the user clicking on one of the contextual ads causes the client system to transmit (36) a URL request to the Kontera Server System. The URL request may be logged (38) in a local database at the Kontera Server System when received. The URL may include embedded information allowing the Kontera Server System to identify various information about the selected ad, including, for example, the identity of the sponsoring advertiser, the keywords(s) associated with the ad, the ad type, etc. The Kontera Server System 304 may use at least a portion of this information to generate (38) redirected instructions for redirecting the client system to the identified advertiser. Additionally, the Kontera Server System may also use at least a portion of the URL information during execution (40) of a dynamic feedback procedure. In at least one embodiment, the dynamic feedback procedure may be implemented to record user click information and impression information associated with various keywords.

As shown at (42), the Kontera Server System transmits the redirected instructions to the client system 302. In response, the client system is redirected to transmit (44) a new URL request to Ad Server 308. The Ad Server may then respond by serving (46) web page content corresponding to the URL request to the client system 302. In at least one embodiment, the web page content sent from the ad Server 308 may include text or other information relevant to content of the web page previously displayed to the user.

FIG. 3B shows an alternate embodiment of flow diagram illustrating various information flows and processes which may occur at various systems in accordance with a specific embodiment.

In the example of FIG. 3B, it is assumed at (1) that a user at the client system 352 has initiated a URL request to view a particular web page (such as, for example, www.yahoo.com), which, for example, is being hosted at web server system 356. Such a request may be initiated, for example, via the Internet using an Internet browser application running at the client system 352.

When the URL request is received at the web server system 356, the web server system may respond by transmitting or serving (3) to the client system the requested page content, which, for example, may include a dynamic context tag containing script instructions (and/or other executable code).

As shown at (5) it is assumed that the page content and dynamic context tag information are received at the client system. In at least one embodiment, the script instructions may include instructions or code intended for execution at the client system which, for example, may cause the client system to initiate communication with a remote system such as, for example, the Kontera Server System 354. More specifically, in the example of FIG. 3B, it is assumed that the client system has initiated processing of the dynamic context tag information which invokes execution (6) of the script instructions which, in turn, causes the client system to transmit (7) all or selected portions of the page content (and/or other information such as, for example, the content provider ID, desired ad type information, etc.) to the Kontera Server System for contextual advertising analysis.

In at least one embodiment, as the Kontera Server System 354 receives the page content, it analyzes (9) (e.g., in real-time) the received page content, and generates (11) page modification instructions which includes ContentLink data relating to one or more ContentLink(s) to be displayed on the client system display.

It is noted that, for purposes of illustration, the contextual advertising and markup techniques disclosed herein are described with respect to the use of ContentLinks. However, other embodiments of the present invention may utilize other types of advertising techniques which, for example, may be used for modifying displayed content (and/or for generating modified content) in order to present desired contextual advertising information on a client device display. Examples of at least some advertising techniques which may be utilized in one or more embodiments of the present invention are described, for example, with respect to FIGS. 4A-G of the drawings.

According to specific embodiments, at least a portion of the page modification instructions and/or ContentLink data may be generated using a variety of conventional on-line contextual advertising techniques such as, for example, those described in: U.S. patent application Ser. No. 10/977,352 (U.S. Publication No. US20050149395A1), and/or U.S. patent application Ser. No. 10/645,313 (U.S. Publication No. US20050004909A1), each of which is incorporated herein by reference in its entirety for all purposes.

In at least one implementation, the Kontera Server System may continue to process the page content until it has generated a sufficient amount of page modification instructions, ContentLink data, and/or until the entirety of the page content has been analyzed.

In at least one embodiment, the page modification instructions and/or ContentLink data may include various information such as, for example: information which describes how specific text and/or other content (e.g., of the page content) is to appear when displayed; information relating to one or more hyperlinks (e.g., ContentLinks) to be included in the display of the page content; information relating to specific advertisements which are associated with one or more ContentLinks such as, for example: title information relating to a selected ad, content relating to the ad, a “click” URL that is to be accessed when the user clicks on the ad, a “landing” URL where the user will eventually be redirected to after the click URL action has been processed, etc.

As shown at (13), the Kontera Server System 354 may send the page modification instructions and/or ContentLink data to the client system 352.

As shown at (15) the client system may use the page modification instructions and/or ContentLink data to display modified page content which includes at least one ContentLink (as shown, for example, in FIG. 4D of the drawings). According to one embodiment, a browser application running at the client system may be operable to modify the page content using the page modification instructions and/or ContentLink data to thereby render modified page content for display on the client system display. In some embodiments, the client system may be operable to processes the page modification instructions to thereby display modified page content formatted in accordance with the web page modification instructions. In other embodiments, the Kontera Server System may perform the task of modifying the original page content to thereby generate the modified page content, which may then be transmitted to the client system for display.

Because the web page modification operations are implemented automatically, in real-time, and without significant delay, such modifications may be performed transparently to the user. Thus, for example, from the user's perspective, when the user requests a particular web page to be retrieved and displayed on the client system, the client system will respond by displaying modified page content which not only includes the original page content, but also includes additional contextual ad information.

In the embodiment of FIG. 3B, it is assumed (for illustrative purposes) that the displayed modified page content includes at least one ContentLink as shown, for example, in FIG. 4D of the drawings. For purposes of illustration, the flow diagram of FIG. 3B, will continue to be described by way of example with reference to FIG. 4D of the drawings.

As illustrated in the embodiment of FIG. 4D, modified page content portion 430 includes a first ContentLink 432a. According to one embodiment, the process of generating ContentLink 432a may include a number of different operations such as, for example: identifying and selecting a portion of text (e.g., “cell phone”) included in the original page content, identifying a first ad or advertisement to be associated with the selected portion of text, converting the selected portion of text (e.g., “cell phone”) into a hyperlink, and/or associating the hyperlink with one or more characteristics relating to the first ad such as, for example: content relating to the ad, a “click” URL that is to be accessed when the user clicks on the ad, a “landing” URL where the user will eventually be redirected to after the click URL action has been processed, etc. In at least one embodiment, the selected portion of text (e.g., “cell phone”) may correspond to a keyword which has been identified by an advertiser and/or ad campaign provider as being related to one or more types of advertising categories and/or topics. As illustrated in the example of FIG. 4D, when the user hovers the mouse pointer over ContentLink 432a, additional information 434 may automatically be displayed to the user, for example, via a mouse-over tool tip layer. In at least one embodiment, the additional information 434 may include ad-related information which is contextually related to ContentLink 432a and/or to other identified keywords and/or topics associated with page content.

It is assumed at (17) (FIG. 3B) that the user of the client system selects (e.g., click on) one of the displayed ContentLinks (e.g., user selects of clicks on ContentLink 432a, FIG. 4D).

In at least one embodiment, the action of the user selecting or clicking on a specific ContentLink (e.g., ContentLink 432a) causes the client system to transmit (19) a URL request and/or other information relating to the selected ContentLink to the Kontera Server System. In one embodiment, ContentLink information sent from the client system to the Kontera Server System may include information allowing the Kontera Server System to identify various information about the selected ad, such as, for example: the identity of the sponsoring advertiser, the keywords(s) associated with the ad, the ad type, landing URL, etc. In one embodiment, information relating to the URL request and/or other information relating to the user's actions may be logged by the Kontera Server System for subsequent analysis.

As shown at (21) the Kontera Server System may log click event information, and may generate a redirect message to be transmitted (e.g., 23) to the client system for redirecting (e.g., 25) the client system to an appropriate landing URL (e.g., the advertiser's site www.orange.co.uk, or to another site selected by the advertiser). In other embodiments, a redirect server (not shown) may be used to redirect the client system to an appropriate landing URL.

### Hybrid Contextual Advertising Technique

According to specific embodiments, various hybrid contextual advertising techniques described herein may be used to enable OCPs to increase revenue while providing valuable services that will keep users coming back to their site and possible viewing more pages.

In at least one embodiment, various hybrid contextual advertising techniques described herein may be configured or designed to work on top of an on-line ad campaign provider's contextual analysis platform (such as, for example, Kontera's contextual analysis platform). In at least one embodiment, the hybrid contextual advertising techniques may be configured or designed to offer the user a combination of content and ads that match the user's interest as inferred from the content (e.g., web page content) that the user is currently viewing.

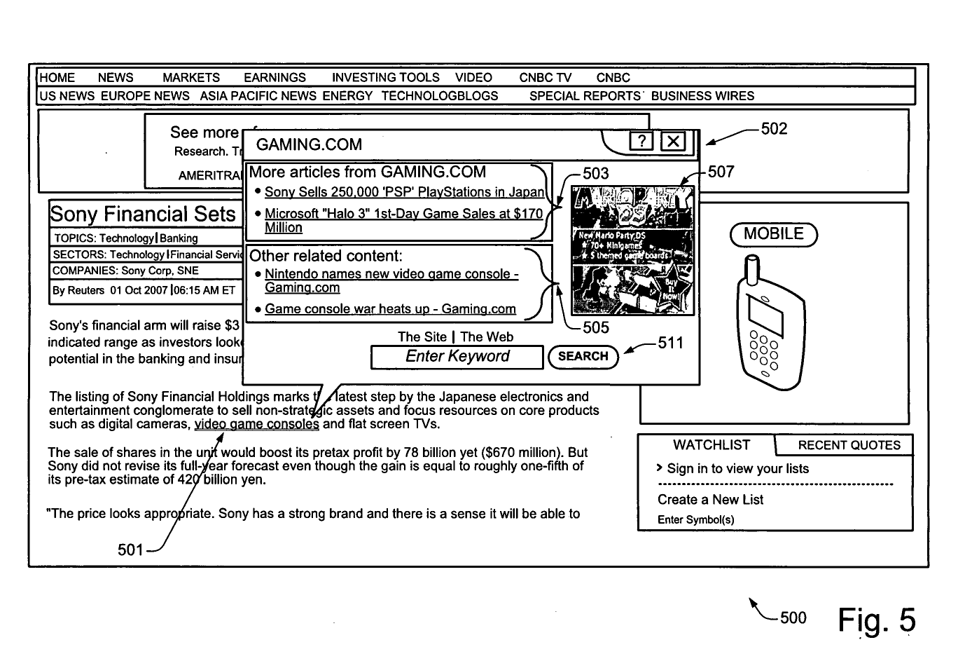

FIG. 5 shows an example of an alternate embodiment of a graphical user interface (GUI) which may be used for implementing various aspects of the hybrid contextual advertising techniques described herein. In the example of FIG. 5, it is assumed that the content of document 500 has been analyzed in accordance with a contextual analysis technique, and that selected keywords of the document have been identified. It is further assumed that at least a portion of the selected keywords have been linked to other selected resources (e.g., web pages, URLs, articles, etc.) using predetermined selection criteria. Thus, for example, as shown in FIG. 5, when a user hovers a cursor over the keyword phrase “video game console” (501), a pop-up window or GUI 502 may be displayed to the user. In the embodiment of FIG. 5, the GUI 502 includes various types of advertiser sponsored information relating to the keyword phrase “video game console.” According to specific embodiments, GUI 502 may include information such as, for example, images, text descriptions, links, video content, search interfaces, dialog boxes, etc. For example, according to specific embodiments:
Related content links (e.g., 503) could be contextually related to content from the current site (e.g., that the user is currently browsing), and/or from additional sites (e.g., 505) that can be affiliated or not affiliated with the current site.
The related content links could lead to content of different format; text, images, video, audio, etc.
The ads could be of different format; text, images (e.g., 507), animations, video, and more.
The ads can originate from any ad server that can provide ads that can be displayed within the campaign provider's contextual analysis platform (such as, for example, Kontera's contextual analysis platform). In at least one embodiment, the Kontera contextual analysis platform may analyze and classify pages into clusters.
An optional search bar/interface (e.g., 511) may be provided that allows the user to search content on the site and/or on affiliated sites. In at least one embodiment, a general web search could be present as well.

### Analysis Process

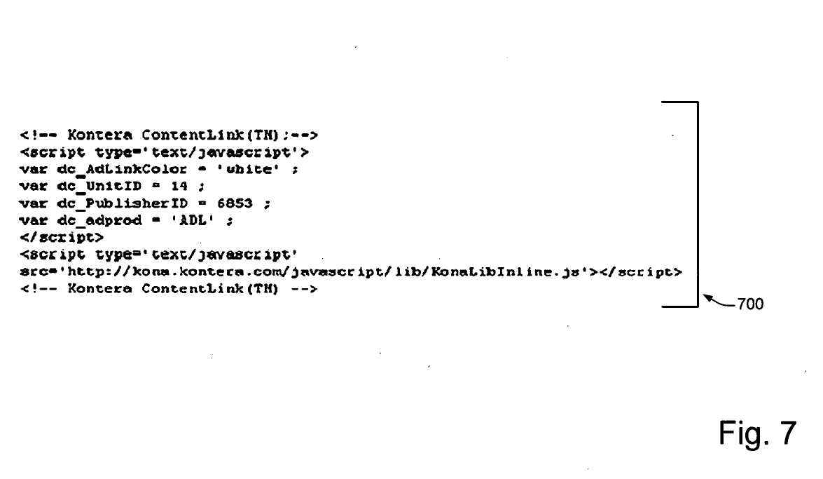

According to a specific embodiment, the OCP may place customized “tags” (herein referred to as Kontera tags) on each page that could be either an origin page, a destination page, or both. FIG. 7 shows an example embodiment of a customized JavaScript (“JS”) Kontera Tag portion 700.

According to a specific embodiment, once a Kontera tag is placed on a page, the page may be analyzed by Kontera's server application when the user browses to this page. In at least one embodiment, a first user that browses and views the page may automatically trigger an analysis process for the page by the Kontera server application (such as, for example, in circumstances where it is the first time that the Kontera server application encounters a page). In at least one embodiment, subsequent instances of additional users that view the page may not require another analysis process to be performed unless, for example, the page's content has changed.

In the analysis process, Kontera's server application may perform a variety of processes such as, for example, one or more of the following (or combinations thereof):
1. Contextual Analysis—This process, for example, may be used to find the preferred or best matching topics and keywords for the page. These may be the topics and/or keywords which may be used to characterize the page's theme.
2. Text Classification Analysis—This process, for example, may be used to compare the page's text and/or other page content to the text/content of other related pages. In at least one embodiment, the related pages may be part of a network of sites and/or pages which may be collectively referred to as a corpus. In at least one embodiment, a corpus may include a plurality of different web pages such as, for example, other web pages associated with the current domain, web pages from other sites affiliated with the current domain, web pages from other sites relating to keywords and/or topics of the current web page, web pages which are neither associated with nor affiliated with the current domain, etc. In some embodiments there may be several different corpuses which may include different (and, in some embodiment, overlapping) networks of sites/pages. In at least one embodiment, the process may include “translating” each (or selected) pages into a respective vector which may be used to represent that page. The vectors may then compared to each other and scored based on the relevance they have to each other.

As a result of implementing the various processes, the system may generate clusters of content sources of different type (e.g., text, video, etc.) that have a relevance score to each other. Each cluster can have one or more associated topics and/or keywords. In at least one embodiment, each page is compared to other pages and the text of each page may be scored against the text of all (or selected) other pages in the same corpus. In at least one embodiment, the process may also assign a similarity score from each page to a list of other pages.

Further, as a result of implementing the various process, the system may generate a list of destination pages for each origin page with a specific relevancy score. The relevancy score tells the system how relevant is the destination page for each origin page. In at least one embodiment, origin pages can also be destination pages.

### Content Sites

In at least one embodiment, the analysis processes may be utilized to analyze pages from the current site, affiliated sites, and/or external sites. For example, if the hybrid contextual advertising technique is currently run on the web page associated with the URL: www.theboyswebsite.com, it can show and link to related content on the that site, and/or it could also link to content on other sites such as, for example, www.thegirlswebsite.com. In at least one embodiment, both sites could display links to each others' content.

In at least one embodiment, the analysis processes may also analyze and cluster content that does not include the customized Kontera tags such as those described above. In such situations, for example, the analysis processes may also analyze and cluster content via remote crawling and analysis of the content. In at least one embodiment, under this mode of operation, there is essentially no limit to the related content that could be featured and it could come from any online site or content repository. For example, related links associated with web pages of the site www.thegirlswebsite.com could feature links to www.ellemagazine.com, www.ivillage.com, etc. without requiring the running or inclusion of Kontera tags on those sites/pages.

In at least one embodiment, the hybrid contextual advertising technique may be configured or designed to such that, without running the Kontera tags on the site, no related links appear on those sites, and therefore such sites may only correspond to destination sites and not origin sites. Thus, for example, in at least one embodiment, a page that includes a Kontera tag may include (or may be modified to display) related links in accordance one or more of the hybrid contextual advertising techniques described herein. Such links may lead the user to additional pages that either include Kontera tags on them or do not include Kontera tags. In one embodiment, a page that does not include a Kontera tag may be used as a destination page, but may be prevented from being used as an origin page (such as those which in which may include or may be modified to display related links in accordance one or more of the hybrid contextual advertising techniques described herein).

### Content Type and Format

According to specific embodiments, various types of content may be analyzed, clustered, and/or displayed as related links. In at least one embodiment it is preferable that the content include either text-based content and/or include textual meta and/or other descriptive data to help classify it (such as, for example, meta tags or tags that classify video, images, and/or audio).

The related content could be displayed within the layer and/or offered as a link to the content destination. For example, in one embodiment, a related video could be displayed within the layer, but the user could also click and view the video in larger format on the destination site.

### Keyword Analysis

In at least one embodiment, a variety of different processes may be implemented during keyword analysis for a given page. Examples of such processes may include, but are not limited to, one or more of the following (or combinations thereof): dynamic keyword discovery analysis, dynamic keyword selection analysis, etc.

### Dynamic Keyword Discovery

In at least one embodiment, as a result of the contextual and/or classification analysis processes described above, the system may generate clusters of content sources of different type (e.g., text, video, etc.) which have been assigned relevance scores with respect to each other. At this stage, the system may preferably select keywords on the page that will serve as the linking agent on the origin page to show the user the layer and links to the related content.

In one embodiment, keywords may be discovered or identified on a selected page using one or more keyword identification techniques such as, for example, one or more of the following (or combinations thereof):
Static Keyword Analysis—Keywords in the page may be identified using a static keyword list and/or hierarchical keyword taxonomy.
Dynamic Keyword Analysis—Keywords in the page may be discovered on the fly when analyzing the page using different methods such as part of speech tagging, natural language processing, heuristics, etc. In at least one embodiment, at least a portion of the identified keywords may not have been available or known before performing the dynamic keyword analysis.

### Dynamic Keyword Selection

In at least one embodiment, once one or more keywords are found and discovered on the origin page, they may be scored according to their relationship to the origin and/or destination pages. In order for the keywords to perform well, it is preferable that the finally selected keywords serve as a contextual connector between the origin and destination pages. Accordingly, in at least one embodiment, it is preferable to select keywords which may be relevant to both the origin and destination pages.

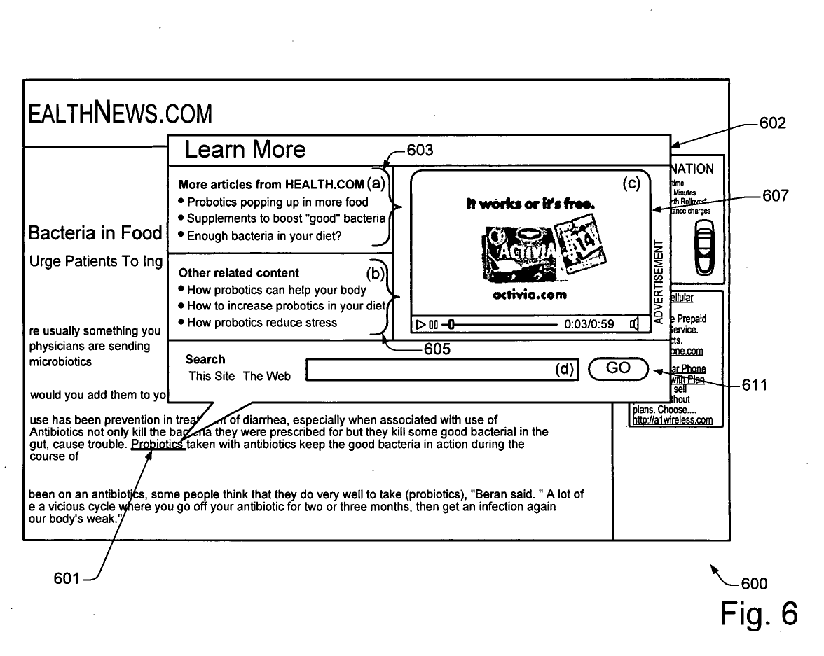

FIG. 6 shows an example of an alternate embodiment of a graphical user interface (GUI) which may be used for implementing various aspects of the hybrid contextual advertising techniques described herein. In the example of FIG. 6, it is assumed that the content of document 600 has been analyzed in accordance with a contextual analysis technique, and that selected keywords of the document have been identified. It is further assumed that at least a portion of the selected keywords have been linked to other selected resources (e.g., web pages, URLs, articles, etc.) using predetermined selection criteria. Thus, for example, as shown in FIG. 6, when a user hovers a cursor over the keyword phrase “Probotics” (601), a pop-up window or GUI 602 may be displayed to the user. In the embodiment of FIG. 6, the GUI 602 includes various types of advertiser sponsored information relating to the keyword phrase “Probotics.” According to specific embodiments, GUI 602 may include information such as, for example, images, text descriptions, links, video content, search interfaces, dialog boxes, etc. For example, according to specific embodiments:
Related content from current site (e.g., 603)—the content can be of different format (textual, images, video, audio, etc.). Related content links could be contextually related to content from the current site (e.g., that the user is currently browsing).
Related content from other sites (e.g., 605)—the list of additional sites could change dynamically and could include a relatively large amount (e.g., network of sites). Such related content may be associated with additional sites that can be affiliated with and/or not affiliated with the current site. In at least one embodiment, the related content information may include or may consist entirely of content which is not provided by the advertiser.
The related content links could lead to content of different format; text, images, video, audio, etc. In one embodiment, related content in the layer could include video and/or images that may be shown in the layer.
The ads could be of different format; text, images, animations, video (e.g., 607), and more.
The ads can originate from any ad server that can provide ads that can be displayed within the campaign provider's contextual analysis platform (such as, for example, Kontera's contextual analysis platform). In at least one embodiment, the Kontera contextual analysis platform may analyze and classify pages into clusters.
An optional search bar/interface (e.g., 611) may be provided that allows the user to search content on the site and/or on affiliated sites. In at least one embodiment, a general web search could be present as well.

This application incorporates by reference in its entirety and for all purposes U.S. patent application Ser. No. 10/977,352 (Attorney Docket No. KABAP004), by Henkin et al., entitled “SYSTEM AND METHOD FOR REAL-TIME WEB PAGE CONTEXT ANALYSIS FOR THE REAL-TIME INSERTION OF TEXTUAL MARKUP OBJECTS AND DYNAMIC CONTENT”, filed Oct. 28, 2004.

This application incorporates by reference in its entirety and for all purposes PCT Application Serial No. PCT/US2007/008042 (Attorney Docket No. KABAP010WO), by Henkin et al., entitled “CONTEXTUAL ADVERTISING TECHNIQUES IMPLEMENTED AT MOBILE DEVICES”, filed Apr. 2, 2007.

Techniques and mechanisms of the present invention will sometimes be described in singular form for clarity. However, it should be noted that particular embodiments include multiple iterations of a technique or multiple instantiations of a mechanism unless noted otherwise.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claim(s).

It is claimed:

1. A method for presenting information to a first end user via a first display of a first client system, the first client system being communicatively coupled to a computer network, the method comprising:
receiving, at the first client system, a first portion of original web page content to be displayed at the first client system, wherein the first portion of original web page content corresponds to a portion of a first web page accessible via a first URL associated with a first content provider;
receiving, at the first client system, a first set of web page modification instructions, wherein the first set of web page modification instructions includes instructions for modifying a displayed appearance of the first portion of original web page content to be displayed at the first client system, wherein the first set of web page modification instructions further includes instructions for displaying a first portion of contextually related information and a second portion of contextually related information at the first client system, and wherein the first and second portions of contextually related information are different from the first portion of original web page content;
displaying, at the first display, during a first time interval, a first portion of displayed content, wherein the displaying of the first portion of displayed content includes displaying the first portion of original web page content at the first display in accordance with the instructions for modifying the displayed appearance of the first portion of original web page content, and wherein the displaying of the first portion of displayed content during the first time interval does not include displaying the first and second portions of contextually related information;
detecting a location of a cursor displayed at the first display being positioned over a first specific portion of the first portion of displayed content; and
automatically displaying, during a second time interval and in response to detecting the location of the cursor being positioned over the first specific portion of the first portion of displayed content, a first overlay layer at the first display, wherein the display of the first overlay layer includes displaying, at the first overlay layer, the first and second portions of contextually related information;
wherein the first portion of contextually related information includes video content which is contextually related to the first portion of original web page content, and wherein the display of the first portion of contextually related information includes displaying, at the first overlay layer, a sequence of video frames corresponding to the video content;
wherein the second portion of contextually related information includes a first portion of text which is contextually related to the first portion of original web page content, wherein the first portion of text is associated with a second web page accessible via a second URL, and wherein the display of the second portion of contextually related information includes displaying, at the second overlay layer, the first portion of text.
